(19) United States
(12) Patent Application Publication
(10) Pub. No.: US 2010/0010403 A1
(43) Pub. Date: Jan. 14, 2010

(54) Mechanical back scratcher / tickler

(76) Inventor: Thomas Fred Haviland, Beavercreek, OH (US)

Correspondence Address: THOMAS F. HAVILAND, 3873 MAPLE GROVE LANE, BEAVERCREEK, OH, 45440, US

(21) Appl. No.: 12/217,895

(22) Filed: Jul. 10, 2008

(51) Int. Cl. A61H 7/00

(52) U.S. Cl. 601/136

(57) ABSTRACT

A rolling tray with dangling stimulators beneath it moves horizontally back and forth over a human who is lying face-down on a floor or bed. The rolling tray is built into a table-shaped housing with legs that are of adjustable height so that the dangling stimulators can make contact with persons of various sizes. The rolling tray moves back and forth via a simple belt and pulley mechanism driven by a low rpm electric motor. Interchangeable dangling stimulators include pointed shapes, rounded shapes, and rollers to achieve various pleasant skin sensations on the back of the user.

### CROSS REFERENCE TO RELATED APPLICATIONS

U.S. Patent Documents

| | | |
|---|---|---|
| 4071021 | January 1978 | Gallacci |
| 5833635 | November 1998 | Aboud, Sr. |
| 5904661 | May 1999 | Bonz |

### STATEMENT OF FEDERALLY SPONSORED RESEARCH/DEVELOPMENT

Not applicable.

### REFERENCE TO A “SEQUENCE LISTING,” A TABLE, OR A COMPUTER PROGRAM LISTING APPENDIX ON A COMPACT DISC

Not applicable.

### BACKGROUND OF THE INVENTION

1. Field of the Invention

The present invention relates to back scratchers, particularly to such apparatus which are mechanically powered.

2. Description of the Related Art

The objective of most back scratching devices, whether they are manually or mechanically operated, is to relieve itching in hard-to-reach areas. That is not the purpose of this invention. The objective of this invention is to provide a delightful, pleasing sensation to the back of a user who is not itching, but who wants to experience a relaxed (not irritating) light tickling or light scratching sensation.

Because most back scratchers are geared to relieve itching, most are designed to be used standing up, standing against a device mounted on a wall or door, or sitting up against a device attached to the arm of a sofa or chair. For those devices, the orientation of the user is not particularly important as long as he/she is getting his/her itch scratched. However, the objective of this invention is for the user to obtain ultimate relaxation, and this is best achieved by allowing the user to lie completely still, face-down under the present invention as it operates.

It is clear that there is a need for a machine that can provide a pleasing tickling/scratching sensation to a person's back while allowing the person to lie face-down, completely still.

### BRIEF SUMMARY OF THE INVENTION

The present invention provides a pleasing tickling/scratching sensation to a person's back while allowing the person to lie face-down, completely still.

In this device, a rolling tray with dangling stimulators beneath it moves horizontally back and forth over a human who is lying face-down on a floor or bed. The rolling tray is built into a table-shaped housing with four legs that are of adjustable height so that the dangling stimulators can make contact with the back of persons of various sizes. The four legs can also be folded parallel to the main housing so that the entire device can be easily stored under a bed or in a closet when not in use.

The rolling tray runs along a horizontal track that is mounted on the inside of the housing and runs the length of the device. The rolling tray moves back and forth via a simple belt and two pulley mechanism driven by a low rpm electric motor. A plate, attached to the belt, makes contact with the rolling tray, allowing the rolling tray to move back and forth along the horizontal track. Because the track is horizontal and the rolling tray and dangling stimulators are very light, very little force is required to move the rolling tray back and forth along the length of the housing.

Interchangeable sets of pointed, rounded, and roller-shaped dangling stimulators can be attached and removed from the bottom side of the rolling tray by the user. The bottom portion of the dangling stimulators are the only part of the device that actually makes contact with the back of the user. The different shapes of the dangling stimulators are used to achieve various pleasant skin sensations such as a light scratching or a light tickling.

Other features and advantages of the present invention will become apparent from the following more detailed description, taken in conjunction with the accompanying drawings, which illustrate the principles of the invention.

### BRIEF DESCRIPTION OF SEVERAL VIEWS OF THE DRAWINGS

FIG. 1 is a perspective view of the preferred embodiment of the invention, showing the direction of movement of the rolling tray and dangling stimulators.

FIG. 2 is a bottom view of the preferred embodiment of the invention, showing the rolling tray, connection points for nine dangling stimulators, and bottom panel of the main housing containing holes for the belt plate and rolling tray rollers.

FIG. 3 is a an interior view of the main housing of the invention, showing the electric motor, belt and pulley mechanism, belt plate, rolling tray with dangling stimulators, and horizontal track.

FIG. 4 is a close up view of one of four identical table legs for the present invention, each leg adjustable in height and capable of folding parallel to the main housing.

FIG. 5 is a close up view of each type of dangling stimulator for the present invention, and shows how the dangling stimulators are attached to the rolling tray using connecting clips.

### DETAILED DESCRIPTION OF THE INVENTION

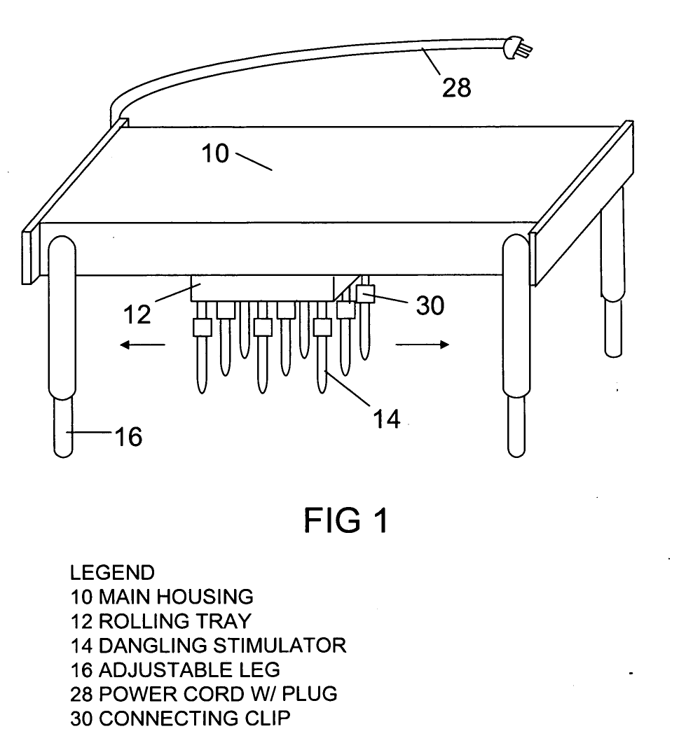

FIG. 1 is a perspective view of the preferred embodiment of the invention, showing the direction of movement of the rolling tray and dangling stimulators.

A person lies beneath the main housing 10. A rolling tray 12 with dangling stimulators 14 beneath it moves horizontally back and forth over a human who is lying face-down on a floor or bed. The rolling tray 12 rides on a horizontal track 18 (not shown in this view) that is built into the main housing 10. The device has four legs 16 that are of adjustable height so that the dangling stimulators 14 can make contact with the back of persons of various sizes. The four legs 16 can also be folded parallel to the main housing 10 so that the entire device can be easily stored under a bed or in a closet when not in use.

In the preferred embodiment, the device has a ten foot power cord with plug 28 and is designed to operate on North American standard 110-120V alternating current at 60 Hz.

In another embodiment (not shown), the device could be designed to operate on European standard 220-240V alternating current at 50 Hz.

In another embodiment (not shown), the device could be designed to operate on alkaline or other battery power.

In the preferred embodiment, the entire device measures approximately 36 inches long, 24 inches wide, and 6 inches tall (with the adjustable legs 16 folded for storage) or 18-24 inches tall (with the adjustable legs 16 in the upright position for use). These dimensions allow the device to be used by most small, medium, or large persons.

In another embodiment (not shown), the entire device could be lengthened to approximately 72 inches, allowing the dangling stimulators 14 to travel above and make contact with the entire length of an average human adult including the user's heels, calves, upper leg, buttock, back, neck, and head, without having to move either the person or the device.

In the preferred embodiment, the majority of the assembly is manufactured from plastic or other material so that the total weight is reduced. The objective is for the device to be light enough to be lifted and carried by just one adult of average strength.

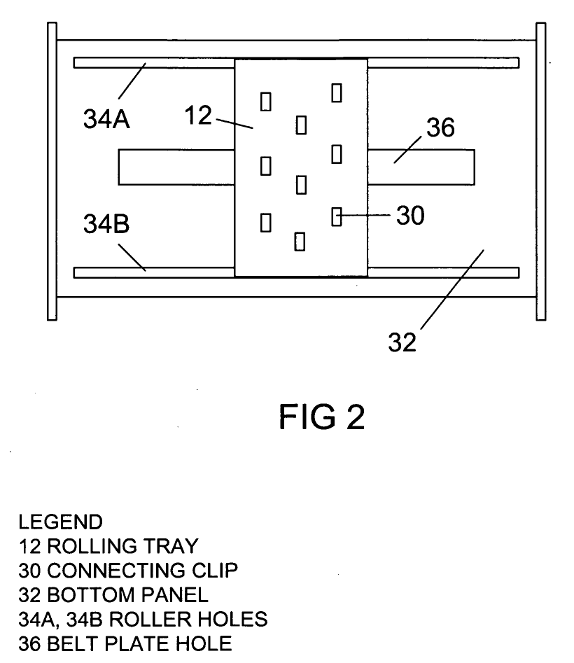

FIG. 2 is a bottom view of the preferred embodiment of the invention, showing the rolling tray 12, connection points 30 for up to nine dangling stimulators, and bottom panel 32 of the main housing. The bottom panel 32 contains a belt plate hole 36 that allows the belt plate (not shown) to extend down through the bottom panel 32 and make contact with the inside walls of the rolling tray 12. The bottom panel 32 also contains two roller holes 34A, 34B that allow the rolling tray 12 to ride along a horizontal track (not shown) located inside the main housing.

In another embodiment (not shown), the number of connection points on the rolling tray 12 for dangling stimulators 14 could be changed from nine to a much larger number, say, up to one hundred to achieve different sensations on the person's back.

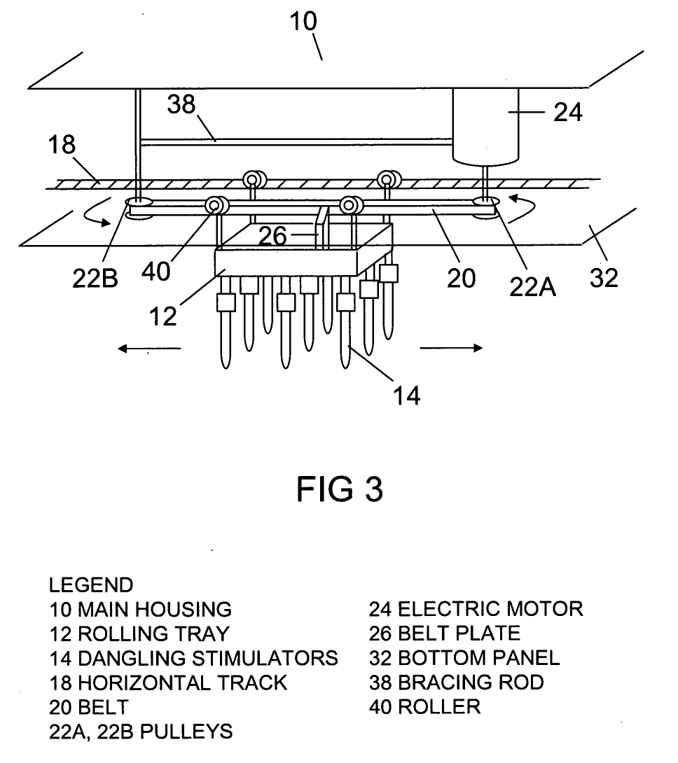

FIG. 3 is a an interior view of the main housing 10 of the invention, showing the electric motor 24, belt 20 and pulley 22A, 22B mechanism, belt plate 26, rolling tray 12 with dangling stimulators 14, and horizontal track 18.

The rolling tray 12 runs along a horizontal track 18 (only one half shown) that is mounted on the inside of the main housing 10 and runs the length of the device. Two rollers 40 on each side of the rolling tray 12 ride along one half of the horizontal track 18. The rolling tray 12 moves back and forth via a simple belt 20 and two pulley 22A, 22B mechanism driven by a low rpm electric motor 24. A bracing rod 38 between the electric motor 24 and the rod for pulley 22B provides stability to the belt and pulley mechanism and keeps the tension of the belt 20 at the proper level. A plate 26, attached to the belt 20, makes contact with the rolling tray 12, allowing the rolling tray 12 to move back and forth along the horizontal track 18. Because the track 18 is horizontal and the rolling tray 12 and dangling stimulators 14 are very light, very little force is required to move the rolling tray 12 back and forth under the bottom panel 32 of the main housing 10.

In the preferred embodiment, the speed of the belt 20 and, therefore, of the rolling tray 12 and dangling stimulators 14 is constant at approximately three inches per second. This speed is achieved by using a 60 rpm electric motor 24 and one-inch diameter pulleys 22A, 22B. This results in the desired effect of a slow, light tickling or scratching sensation on the user's back.

In another embodiment (not shown), the speed of the belt 20 and, therefore, of the rolling tray 12 and dangling stimulators 14 could be controlled by the user, with variable speeds from, say, one inch per second minimum to twelve inches per second maximum. This can be achieved by using a variable-speed controlled electric motor.

In the preferred embodiment, the two pulleys 22A, 22B are oriented horizontally, one near each end of the main housing 10, and the belt 20 travels around the pulleys 22A, 22B in a horizontal plane that is parallel to and just above the rolling tray 12. A low rpm electric motor 24 inside the rear of the housing having a vertical drive shaft extends into said housing and is secured to one of the two pulleys 22A. A plate 26 that is attached to the belt 20 and extends down (herein referred to as the “belt plate” 26) makes contact with, but is not fastened to, the inside walls (forward and rear) of the rolling tray 12. This allows the belt plate 26 to push the rolling tray 12 and to break contact with the rolling tray 12 as the belt plate 26 travels around either of the pulleys 22A, 22B and starts traveling in the opposite direction. The belt plate 26 then makes contact with the opposite inside wall of the rolling tray 12 and pushes the rolling tray 12 to the other end of the main housing 10, where it breaks contact again, travels around the pulley 22A or 22B, then pushes the rolling tray 12 back in the other direction.

In another embodiment (not shown), the two pulleys 22A, 22B are oriented vertically, one near each end of the main housing 10, and the belt 20 travels around the pulleys 22A, 22B in a vertical plane, but where the bottom half of the belt loop is still parallel to and just above the rolling tray 12. A low rpm electric stepper controlled motor inside the rear of the housing having a horizontal drive shaft extends into said housing and is secured to one of the two pulleys 22A. A plate 26 that is attached to the bottom half of the belt loop and extends down (herein referred to as the “belt plate” 26) makes contact with, but is not fastened to, the inside walls (forward and rear) of the rolling tray 12. This allows the belt plate 26 to push the rolling tray 12 to one end of the main housing 10. The stepper motor then reverses direction and the belt plate 26 pushes the rolling tray 12 in the opposite direction to the other end of the main housing 10. The stepper motor reverses direction again and the process repeats.

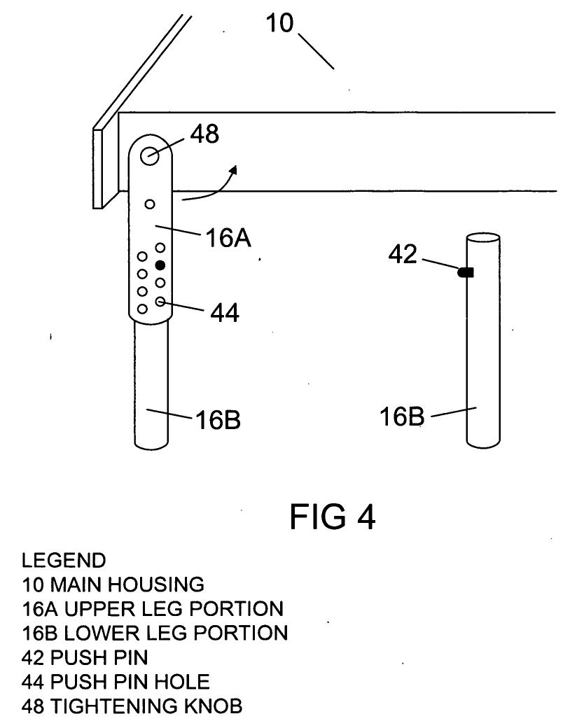

FIG. 4 is a close up view of one of four identical table legs 16A, 16B for the present invention, each leg adjustable in height and capable of folding parallel to the main housing 10 as shown. A tightening knob 48 is used to secure each leg in the desired position, either upright for use or parallel to the main housing for storage.

The upper leg portion 16A is greater in diameter than the lower leg portion 16 B of each leg. This allows the lower leg portion 16B to slide up or down inside the hollow upper leg portion 16A. The lower leg portion 16B has a push pin 42 that will pop out in one of nine push pin holes 44 located in the upper leg portion 16A. The user can adjust the height of each leg by selecting any one of the eight push pin holes 44 spaced about one inch apart at the bottom of the upper leg portion 16A, or can prepare the leg for storing by selecting the lone push pin hole 44 located higher on the upper leg portion 16A.

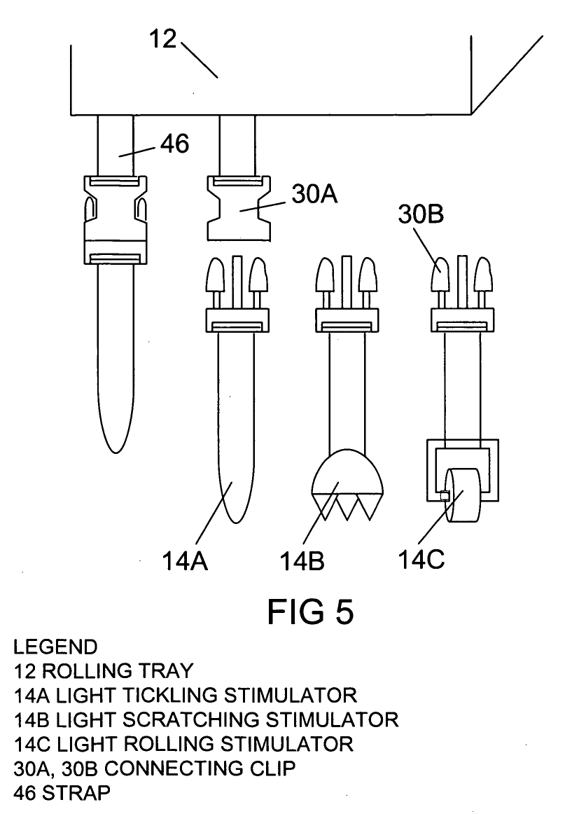

FIG. 5 is a close up view of each type of dangling stimulator 14 for the present invention, and shows how the dangling stimulators 14 are attached to the rolling tray 12 using connecting clips.

In the preferred embodiment, interchangeable sets of rounded 14A, pointed 14B, and roller-shaped 14C dangling stimulators 14 can be attached and removed from the bottom side of the rolling tray 12 by the user. The bottom portion of the dangling stimulators 14 are the only part of the device that actually makes contact with the back of the user. The different shapes of the dangling stimulators 14 are used to achieve various pleasant skin sensations such as a light scratching or a light tickling.

In the preferred embodiment, the length of each dangling stimulator 14, regardless of type, is approximately six inches (including its strap 46 and connecting clip 30A, 30B). Each of the dangling stimulators 14 can be connected to the rolling tray 12 at any or all of the nine connecting clips 30A.

In another embodiment (not shown), new dangling stimulators 14 could be developed to achieve an even greater degree of different skin sensations by varying the shape, weight, and/or composition material of the dangling stimulator 14.

The invention claimed is:

1. A back scratcher/tickler for use by a person lying down comprising:
a. a rolling tray that moves horizontally back and forth with dangling stimulators beneath it;
b. the rolling tray built into a table-shaped housing with a horizontal track;
c. a low rpm electric motor inside the rear of the housing having a vertical drive shaft extending into said housing and secured to a pulley and belt mechanism that runs above and parallel to the rolling tray; and
d. a plate attached to the belt that also makes contact with the rolling tray, allowing the rolling tray to move back and forth along the horizontal track.

2. The back scratcher/tickler of claim 1, further comprising four legs to support the main housing, each leg adjustable in height, and each leg capable of folding parallel to the main housing.

3. The back scratcher/tickler of claim 1, further comprising interchangeable sets of pointed, rounded, and roller-shaped dangling stimulators that can be attached and removed from the bottom side of the rolling tray by the user.
